(19) United States
(12) Patent Application Publication
(10) Pub. No.: US 2009/0136032 A1
(43) Pub. Date: May 28, 2009

(54) IMAGE READING APPARATUS AND IMAGE FORMING APPARATUS

(75) Inventor: Ryouta Tamura, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/276,954

(22) Filed: Nov. 24, 2008

(30) Foreign Application Priority Data
Nov. 26, 2007 (JP) 2007-304840

(51) Int. Cl. H04N 1/44; G06F 15/00; H04L 9/06

(52) U.S. Cl. 380/243; 358/1.15; 380/44; 380/46

(57) ABSTRACT

An image reading apparatus includes: an original reading section reading an image from an original and generating image data on the read image; a key generation section generating a key for encrypting on the basis of the image data generated by the original reading section; an encrypting section encrypting the image data generated by the original reading section with the key generated by the key generation section; and a transmission section transmitting the image data encrypted by the encrypting section to a terminal connected with the outside.

### BACKGROUND OF THE INVENTION

1. Field of the Invention

The present invention relates to an image reading apparatus which encrypts and transmits image data read from an original, and an image forming apparatus which forms an image on paper on the basis of image data obtained by the image reading apparatus.

2. Description of the Related Art

In recent years, companies, the national government, municipal corporations and the like have the grave problem of secret-information leakage, thereby demanding a technology for preventing confidential papers from leaking out. Those organizations have actively introduced information technology (IT) to turn paper documents into electronic ones, thereby promoting information sharing, reduction in management expenses, or the like.

An image forming apparatus such as a copying machine has also been digitized to thereby acquire an original image in the form of electronic data and transmit image data read from the original to another terminal over a network. Further, a complex machine having the functions of copying as well as scanning, printing, facsimile and the like has been popular, and a network scanner transmitting image data read from an original to another terminal over a network has also been in common use. Those apparatuses have contributed toward converting paper documents into electronic ones.

However, image data on a network may be wiretapped, thus requiring an art of encrypting and transmitting image data read from an original. Various encrypting methods are employed, for example, a DES (data encryption standard), an AES (advanced encryption standard) and the like, in which a random-number generator generates a key for encrypting and decoding.

As an encrypting key, a pseudo-random number using software algorithm can be employed. However, the pseudo-random number is at a low disorder level, thereby lowering the encrypting strength. In order to make the encrypting strength greater in cryptographic communication, a random number closer to a real random number than a pseudo-random number needs to be generated in a known method using a white-noise generator or a ring oscillator or in a devised method using uncertain physical phenomena or biological information (e.g., refer to Japanese Patent Laid-Open Publication No. 2005-025298 and Japanese Patent Laid-Open Publication No. 2006-309417).

However, cryptographic communication in the above random-number generation method for generating a random number closer to a real random number than a pseudo-random number requires a circuit dedicated to random-number generation for creating codes, or a transducer detecting external physical phenomena or biological information, thereby raising the costs.

### SUMMARY OF THE INVENTION

In view of the above disadvantages, it is an object of the present invention to provide an image reading apparatus and an image forming apparatus capable of heightening the disorder level of a random number used as a key for cryptographic communication while suppressing a rise in costs.

An image reading apparatus according to an aspect of the present invention includes: an original reading section reading an image from an original and generating image data on the read image; a key generation section generating a key for encrypting on the basis of the image data generated by the original reading section; an encrypting section encrypting the image data generated by the original reading section with the key generated by the key generation section; and a transmission section transmitting the image data encrypted by the encrypting section to a terminal connected with the outside.

According to this configuration, the original reading section reads an image from an original and generates image data on the read image; the key generation section generates a key for encrypting on the basis of the image data generated by the original reading section; the encrypting section encrypts the image data generated by the original reading section with the key generated by the key generation section; and the transmission section transmits the image data encrypted by the encrypting section to a terminal connected with the outside.

This varies the image data every time the original is read, thereby randomly changing the key value generated on the basis of the image data to realize a key having a higher random-number disorder level. Therefore, the random number can be disordered without any circuit dedicated to random-number generation, thereby suppressing a rise in costs necessary for heightening the random-number disorder level.

An image forming apparatus according to an aspect of the present invention includes: the above image reading apparatus; and an image formation section forming an image onto paper on the basis of the image data generated by the original reading section.

According to this configuration, the image forming apparatus provided with the image reading apparatus is capable of heightening the disorder level in an encrypting key and disordering the random number further without any circuit dedicated to random-number generation, thereby suppressing a rise in costs for heightening the random-number disorder level.

These and other objects, features and advantages of the present invention will become more apparent upon reading of the following detailed description along with the accompanied drawings.

### BRIEF DESCRIPTION OF THE DRAWINGS

FIG. 1 is a block diagram showing a configuration of an image forming apparatus according to an embodiment of the present invention.

FIG. 2 is a flow chart showing an operation of the image forming apparatus of FIG. 1.

FIG. 3 is a flow chart showing a variation of FIG. 2.

FIG. 4 is a flow chart showing another variation of FIG. 2.

### DETAILED DESCRIPTION OF THE PREFERRED EMBODIMENTS

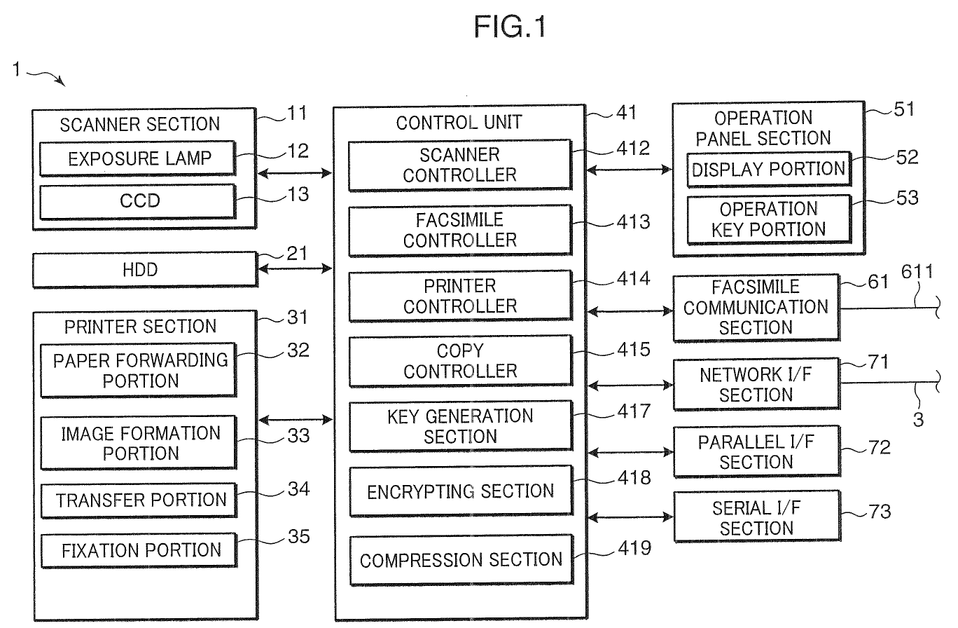

Embodiments of the present invention will be below described with reference to the drawings. In each figure, component elements are given the same reference numerals and characters as long as they are identical, and their description is omitted. FIG. 1 is a block diagram showing a configuration of an image forming apparatus according to an embodiment of the present invention. An image forming apparatus 1 shown in FIG. 1 is a so-called complex machine having several image-forming functions of copying, printing, faxing, scanning and the like.

The image forming apparatus 1 includes a scanner section 11 (original reading section), an HDD (hard disk drive) 21 (storage section), a printer section 31 (image formation section); a control unit 41, an operation panel section 51, a facsimile communication section 61, a network I/F section 71 (transmission section), a parallel I/F section 72 (transmission section) and a serial I/F section 73 (transmission section).

The scanner section 11, HDD 21, control unit 41, operation panel section 51, network I/F section 71, parallel I/F section 72 and serial I/F section 73 constitute an example of the image reading apparatus, thereby realizing a network scanning function of encrypting retrieved image data, transmitting it as electronic mail to a terminal having a mail address designated in advance or directly to an IP address of a terminal, or a scanning function of transmitting the encrypted image data to a terminal connected to the parallel I/F section 72 or the serial I/F section 73.

The scanner section 11, HDD 21, printer section 31, control unit 41, operation panel section 51 and facsimile communication section 61 realizes a faxing function, the HDD 21, printer section 31, control unit 41, operation panel section 51, network I/F section 71, parallel I/F section 72 and serial I/F section 73 realizes a printing function and the scanner section 11, HDD 21, printer section 31, control unit 41 and operation panel section 51 realizes a copying function.

The operation panel section 51 is manipulated by a user to execute an operation such as the copying function, printing function, faxing function and scanning function, and gives the control unit 41 an instruction to operate by the user, for example, an image forming instruction to print out information stored in the HDD 21. The operation panel section 51 includes a display portion 52 having a touch panel or the like and an operation key portion 53 having a start key, a ten key or the like.

The display portion 52 includes a displayable touch-panel unit formed by combining a touch panel and an LCD (liquid crystal panel) or the like and displays various operation images for inputs. The display portion 52 displays, for example, information on a user selection, a sender selection, transmission setting or the like when executing the faxing function and operation buttons or the like touched by a user for inputting various operation instructions. The operation key portion 53 is used for inputting various instructions such as instructions to start copying and faxing by a user.

The scanner section 11 acquires an original image optically and generates image data. It includes an exposure lamp 12 and a CCD (charge-coupled device) 13. The scanner section 11 allows the exposure lamp 12 to irradiate original paper and the CCD 13 to receive the reflected light to thereby read the original image and output image data corresponding to the read image to the control unit 41. The scanner section 11 may read not only a monochromatic original but also a color or photographic original.

The HDD 21 is, for example, a storage device storing image data on an original encrypted by the control unit 41.

The printer section 31 acquires, from the control unit 41, image data on an original read by the scanner section 11, image data received via the network I/F section 71 from an external personal computer or the like and image data such as fax data received via the facsimile communication section 61 from an external facsimile device, and prints an image corresponding to such image data onto a sheet of paper.

The printer section 31 is, for example, an electro-photographic image formation section including: a paper forwarding portion 32 having a paper feed cassette, a paper feed roller and the like; an image formation portion 33 having an intermediate transfer-body roller, a photosensitive drum, an exposure unit, a development unit and the like; a transfer portion 34 having a transfer roller and the like; and a fixation portion 35 having a fixation roller and the like. Specifically, the paper forwarding portion 32 forwards paper to the image formation portion 33, the image formation portion 33 forms a toner image corresponding to the above image data, the transfer portion 34 transfers the toner image onto the paper and the fixation portion 35 fixates the toner image on the paper to form an image.

The printer section 31 is not limited to adopting the electro-photographic method for forming an image with toner, and thus, various methods can be employed, for example, an ink jet method for forming an image by jetting ink out onto paper, a thermal transfer method for transferring an image onto paper by giving heat to an ink film, or the like.

The facsimile communication section 61 includes an encoding/decoding portion (not shown), a modulation demodulation portion (not shown) and an NCU (network control unit: not shown). It transmits image data on an original read by the scanner section 11 to another facsimile device through a communication line 611 such as a telephone line and an Internet line, or receives image data sent from another facsimile device. The encoding/decoding portion compresses and encodes image data to be transmitted and expands and decodes received image data. The modulation demodulation portion modulates compressed and encoded image data to an aural signal or demodulates a received signal (aural signal) to image data. The NCU controls the telephone-line connection with a facsimile device at a transmission destination.

The network I/F section 71 controls the transmission and reception of various kinds of data with a terminal (not shown) connected via a network 3, using a network interface (e.g., 10/100 base-TX) or the like. For example, it transmits original image data read by the scanner section 11 and encrypted by the control unit 41 as electronic mail to a terminal (not shown), or receives image data sent from a terminal (not shown) for printing in the printer section 31.

The parallel I/F section 72 receives printing data or the like from a terminal (not shown) through parallel transmission for sending data in a unit of several bits with a plurality of signal lines, using a high-speed bidirectional parallel interface (e.g., in conformity to IEEE1284) or the like, or the like. The serial I/F section 73 receives various kinds of data or the like from a terminal (not shown) through serial transmission for sending each bit of data one by one with a single signal line, using a serial interface (e.g., RS-232C) or the like, or the like.

A terminal to be connected to the network I/F section 71, parallel I/F section 72 and serial I/F section 73 may be, for example, a personal computer, another image forming apparatus or any other information processor.

The control unit 41 includes, for example: a CPU (or central processing unit) which executes a predetermined arithmetic processing; anon-volatile ROM (or read only memory) which has a predetermined control program stored therein; a RAM (or random access memory) which stores data temporarily; peripheral circuits thereof; and the like. Thereby, it controls the whole image forming apparatus 1 according to instruction information accepted by the operation panel section 51 or the like, or a detection signal from a sensor arranged in each part of the image forming apparatus 1.

For example, the control unit 41 executes a control program stored in the ROM to thereby function as a scanner controller 412, a facsimile controller 413, a printer controller 414, a copy controller 415, a key generation section 417, an encrypting section 418 and a compression section 419. The key generation section 417, encrypting section 418 and compression section 419 may be formed, for example, by a dedicated circuit such as an ASIC (application specific integrated circuit).

The scanner controller 412 controls the operation of each part used for realizing a scanning function. For example, if the operation panel section 51 accepts an instruction to start scanning, the scanner controller 412 allows the scanner section 11 to read an original image and the compression section 419 to compress image data on the original image generated by the scanner section 11 for creating compressed image data.

Sequentially, the scanner controller 412 stores the compressed image data created by the compression section 419 in the HDD 21, allows the key generation section 417 to generate an encrypting key on the basis of the compressed image data stored in the HDD 21 and stores the key in the HDD 21.

For example, if the operation panel section 51 accepts an instruction to transmit the image data, the scanner controller 412 allows the encrypting section 418 to encrypt the compressed image data stored in the HDD 21 using the key generated by the key generation section 417 and allows, for example, the network I/F section 71 to transmit the encrypted image data to a terminal (not shown) via the network 3.

The facsimile controller 413 controls the operation of each part used for realizing a faxing function. When faxing, it designates a telephone number stored in the HDD 21 and allows the facsimile communication section 61 to transmit image data on an original read by the scanner section 11 directly to a facsimile device or the like through the communication line 611. The printer controller 414 controls the operation of each part used for realizing a printing function.

The copy controller 415 controls the operation of each part used for realizing a copying function. For example, if the operation panel section 51 accepts an instruction to start copying, the copy controller 415 allows the scanner section 11 to read an original image and the compression section 419 to compress image data on the original image generated by the scanner section 11 for creating compressed image data.

Sequentially, the copy controller 415 stores the compressed image data created by the compression section 419 in the HDD 21, allows the key generation section 417 to generate an encrypting key on the basis of the compressed image data stored in the HDD 21 and stores the key in the HDD 21. On the basis of the compressed image data stored in the HDD 21, it allows the printer section 31 to form an image onto a sheet of paper.

The key generation section 417 generates a key by giving at least a part of the image data which is compressed by the compression section 419 and stored in the HDD 21 an arithmetic processing using a hash function. Alternatively, the key generation section 417 may generate a key on the basis of image data not compressed which is generated by the scanner section 11, or encrypts a generated key and store it in the HDD 21 or the RAM, thereby holding the key information more secret with the generated key kept stored in the image forming apparatus 1.

The encrypting section 418 encrypts compressed image data stored in the HDD 21 with an encrypting key generated by the key generation section 417 to thereby create encrypted data. Then, it transmits the encrypted data via the network I/F section 71, the parallel I/F section 72 or the serial I/F section 73 to a terminal (not shown) connected to each I/F section. The encrypting section 418 may transmit, to a terminal (not shown), the key in timing different from the encrypted data, for example, using the I/F sections, or notify the terminal (not shown) of the key by other means.

The encrypting section 418 can be provided with various encrypting methods, for example, a DES (data encryption standard), an AES (advanced encryption standard) and the like.

The compression section 419 compresses image data generated by the scanner section 11 and stores it in the HDD 21. It adopts a compression method such as a JPEG (joint photographic expert group) and an MMR (modified modified relative element address designate: ITU-T T.6), thereby reducing the amount of data in transmitting image data to a terminal.

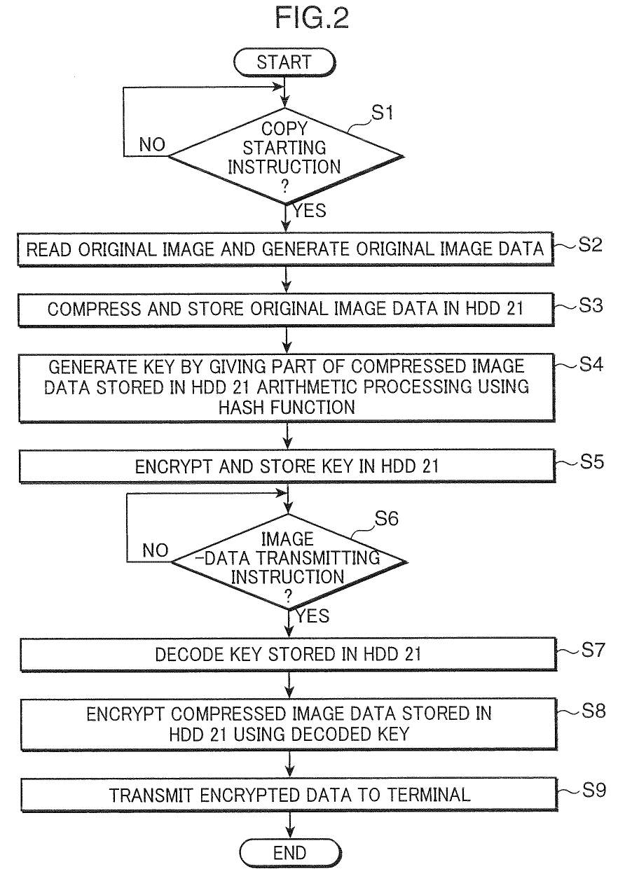

Next, an operation will be described of the thus configured image forming apparatus 1. FIG. 2 is a flow chart showing an operation of the image forming apparatus 1 of FIG. 1. In the following flow charts, the same operations are given the identical step numbers, and their description is omitted.

First, for example, if a user operates the operation panel section 51, for example, by pressing a start key or doing such another in such a way that the operation panel section 51 accepts an instruction to start copying (YES in a step S1), then in response to a control signal from the copy controller 415, the scanner section 11 reads an image on original paper to generate data on the original image (in a step S2).

Next, the original image data generated by the scanner section 1 is compressed by the compression section 419 and stored in the HDD 21 (in a step S3). Then, the key generation section 417 gives a part of the compressed image data stored in the HDD 21, for example, approximately one-kilobyte data from the head of the compressed image data, an arithmetic processing using a hash function to thereby generate a key (in a step S4).

This varies the compressed image data every time the original is read, thereby randomly changing the key value generated on the basis of the compressed image data. Therefore, the thus obtained key has a higher disorder level as the random number. Besides, the random number can be disordered without any circuit dedicated to random-number generation, thereby suppressing a rise in costs necessary for heightening the random-number disorder level.

The key generation section 417 may also generate a key using image data on an original generated by the scanner section 11, not using compressed image data. However, image data on an original can have regularity depending upon an image to be read; compressed image data to be obtained by compressing this has a higher disorder level. Accordingly, the key generation section 417 generates a key using compressed image data, thereby further disordering the random number thereof.

The position of data to undergo an arithmetic processing using a hash function is not limited to the head of compressed image data and may also be set, for example, to the position of data to be given an arithmetic processing at random. Alternatively, it may be appreciated that the key generation section 417 generates a key by giving all compressed image data an arithmetic processing using a hash function.

Data to undergo an arithmetic processing is a part of compressed image data, thereby reducing the hash-function arithmetic throughput. Besides, the position of data to undergo an arithmetic processing at random is set, thereby heightening the disorder level of a key obtained as a random number and raising the encrypting strength by the encrypting section 418.

Next, the key generation section 417 encrypts the key and stores it in the HDD 21 (in a step S5), thereby holding the key information more secret with the generated key kept stored in the image forming apparatus 1.

Sequentially, for example, if the user operates the operation panel section 51 in such a way that the operation panel section 51 accepts an instruction to transmit the image data (YES in a step S6), the encrypting section 418 decodes the key stored in the HDD 21 (in a step S7). Then, the encrypting section 418 encrypts the compressed image data stored in the HDD 21 using the decoded key (in a step S8).

For example, the network I/F section 71 transmits the encrypted data via the network 3 to a terminal (not shown) (in a step S9).

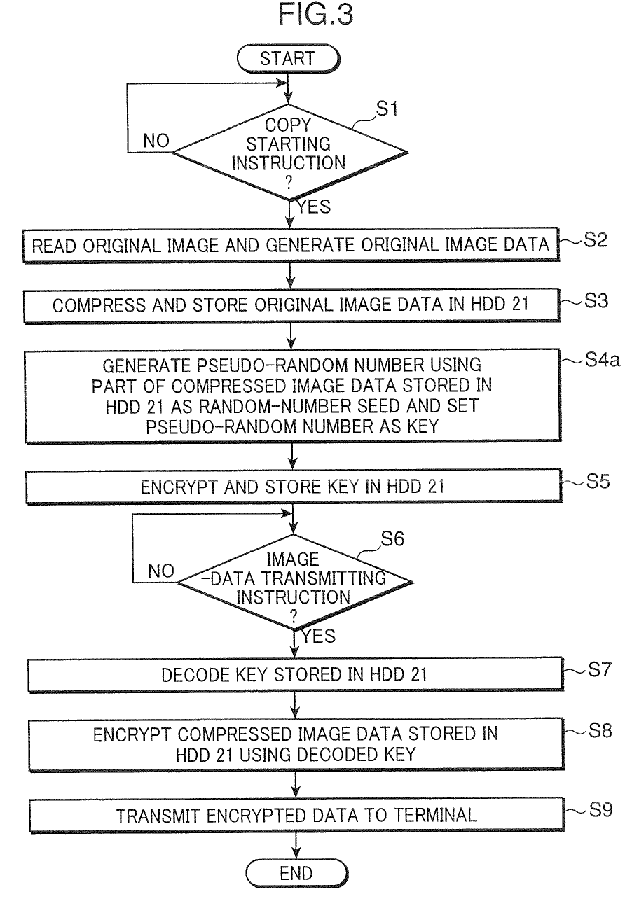

Alternatively, it may be appreciated that in a step S4a of FIG. 3, for example, the key generation section 417 generates a pseudo-random number using a part of the compressed image data stored in the HDD 21, for example, approximately one-kilobyte data from the head thereof as a random-number seed and sets the pseudo-random number as the key. This varies the compressed image data every time an original is read, thereby randomly changing the random-number seed. Therefore, the thus obtained pseudo-random number using the random-number seed has a higher disorder level. Besides, the random number can be disordered without any circuit dedicated to random-number generation, thereby suppressing a rise in costs necessary for heightening the random-number disorder level.

In addition, compressed image data obtained by compressing image data on an original has a higher disorder level than the original image data not compressed. Accordingly, the key generation section 417 generates a pseudo-random number using the compressed image data as a random-number seed to thereby create a key having a further disordered random number. Furthermore, the position of data to be used as a random-number seed is not limited to the head of compressed image data and may also be set, for example, to the position of data to be given an arithmetic processing at random. Alternatively, it may be appreciated that the key generation section 417 generates a pseudo-random number using all compressed image data as a random-number seed to thereby create a key.

Data to undergo an arithmetic processing is a part of compressed image data, thereby reducing the arithmetic throughput necessary for generating a pseudo-random number. Moreover, the position of data to undergo an arithmetic processing at random is set, thereby heightening the disorder level of a key obtained as a random number and raising the strength of encrypting by the encrypting section 418.

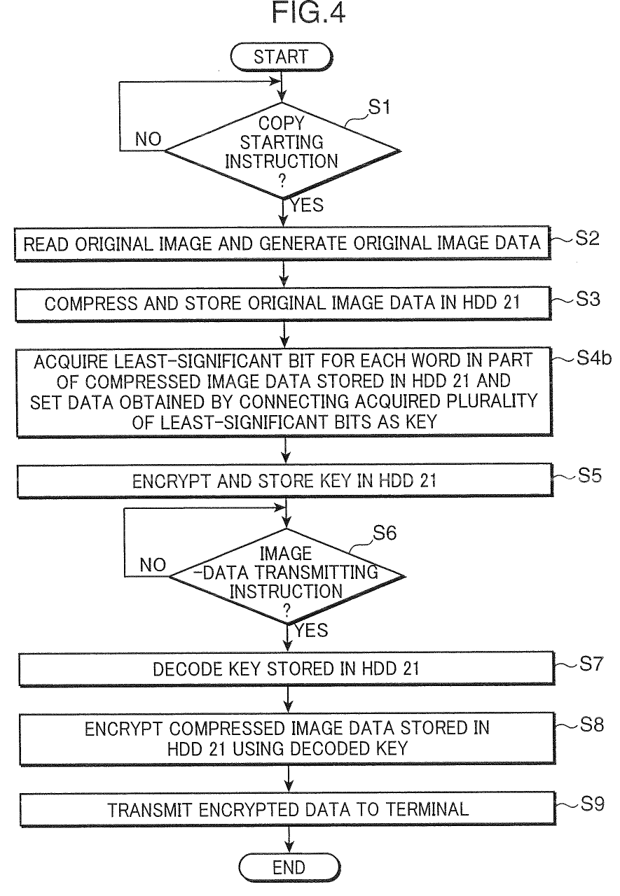

Alternatively, it may be appreciated that in a step S4b of FIG. 4, for example, the key generation section 417 acquires a least-significant bit for each byte (word) in a part of the compressed image data stored in the HDD 21, for example, approximately eight-kilobyte data from the head thereof and sets data obtained by connecting the acquired plurality of least-significant bits as the key.

In this case, the compressed image data varies every time an original is read, thereby randomly changing the least-significant bit for each byte. Therefore, the key obtained by connecting the least-significant bits has a higher disorder level. In addition, the least-significant bit in each pixel value of the image data read from the original contains a white noise, thereby raising the data disorder level. Besides, the random number can be disordered without any circuit dedicated to random-number generation, thereby suppressing a rise in costs necessary for heightening the random-number disorder level.

Furthermore, compressed image data obtained by compressing image data on an original has a higher disorder level than the original image data not compressed. Accordingly, the key generation section 417 acquires a least-significant bit for each byte (word) in the compressed image data and sets data obtained by connecting the acquired plurality of least-significant bits as the key to thereby create a key having a further disordered random number. Furthermore, the position of data to be used for acquiring a least-significant bit is not limited to the head of compressed image data and may also be set, for example, to the position of data to be used for acquiring a least-significant bit at random. Alternatively, it may be appreciated that the key generation section 417 acquires least-significant bits from all compressed image data to thereby create a key.

Data to be used for acquiring least-significant bits is a part of compressed image data, thereby reducing the throughput necessary for acquiring the least-significant bits. Moreover, the position of data to undergo an arithmetic processing at random is set, thereby heightening the disorder level of a key obtained as a random number and raising the strength of encrypting by the encrypting section 418.

In sum, an image reading apparatus according to an aspect of the present invention includes: an original reading section reading an image from an original and generating image data on the read image; a key generation section generating a key for encrypting on the basis of the image data generated by the original reading section; an encrypting section encrypting the image data generated by the original reading section with the key generated by the key generation section; and a transmission section transmitting the image data encrypted by the encrypting section to a terminal connected with the outside.

According to this configuration, the original reading section reads an image from an original and generates image data on the read image; the key generation section generates a key for encrypting on the basis of the image data generated by the original reading section; the encrypting section encrypts the image data generated by the original reading section with the key generated by the key generation section; and the transmission section transmits the image data encrypted by the encrypting section to a terminal connected with the outside.

This varies the image data every time the original is read, thereby randomly changing the key value generated on the basis of the image data to realize a key having a higher random-number disorder level. Therefore, the random number can be disordered without any circuit dedicated to random-number generation, thereby suppressing a rise in costs necessary for heightening the random-number disorder level.

Furthermore, it is preferable that a storage section storing information is further provided; the key generation section encrypts the generated key and stores this key in the storage section; and the encrypting section decodes the key stored in the storage section and uses this key for encrypting the image data.

According to this configuration, the key generated by the key generation section is encrypted and stored in the storage section, and the encrypting section decodes the key stored in the storage section and uses this key for encrypting the image data, thereby holding the key information more secret with the generated key kept in storage in the storage section.

Moreover, preferably, the key generation section may generate the key by giving at least a part of the image data generated by the original reading section an arithmetic processing using a hash function.

According to this configuration, the key generation section generates a key by converting at least a part of image data which varies every time an original is read into a random data row, through an arithmetic processing using a hash function, thereby heightening the disorder level in the key.

In addition, the key generation section may generate a pseudo-random number using at least a part of the image data generated by the original reading section as a random-number seed and set the generated pseudo-random number as the key.

According to this configuration, the key generation section generates a pseudo-random number using at least a part of image data which varies every time an original is read as a random-number seed and sets the generated pseudo-random number as the key, thereby heightening the disorder level in the key.

Furthermore, the key generation section may acquire a least-significant bit for each word in at least a part of the image data generated by the original reading section and generate the key using the acquired plurality of least-significant bits.

According to this configuration, the key generation section acquires a least-significant bit containing a white noise for each word in at least a part of image data which varies every time an original is read and generates the key using the acquired plurality of least-significant bits, thereby heightening the disorder level in the key.

Moreover, it is preferable that a compression section is further provided which compresses the image data generated by the original reading section; and the key generation section generates the key on the basis of the image data compressed by the compression section.

According to this configuration, the image data generated by the original reading section is compressed and further disordered by the compression section. The key is created on the basis of the compressed and further disordered image data, thereby heightening the disorder level in the key.

In addition, preferably, the key generation section may generate the key by giving at least a part of the image data compressed by the compression section an arithmetic processing using a hash function.

According to this configuration, image data which varies every time an original is read is compressed and further disordered by the key generation section. Then, the key is created by converting at least a part of the thus further disordered data into a random data row through an arithmetic processing using a hash function, thereby heightening the disorder level in the key.

Furthermore, the key generation section may generate a pseudo-random number using at least a part of the image data compressed by the compression section as a random-number seed and set the generated pseudo-random number as the key.

According to this configuration, image data which varies every time an original is read is compressed and further disordered by the key generation section. Then, the key is created by generating a pseudo-random number using at least a part of the thus further disordered data as a random-number seed and setting the generated pseudo-random number as the key, thereby heightening the disorder level in the key.

Moreover, the key generation section may acquire a least-significant bit for each word in at least a part of the image data compressed by the compression section and generate the key using the acquired plurality of least-significant bits.

According to this configuration, image data which varies every time an original is read is compressed and further disordered by the key generation section. Then, a least-significant bit containing a white noise for each word in at least a part of the thus further disordered data is acquired to generate the key using the acquired plurality of least-significant bits, thereby heightening the disorder level in the key.

In addition, an image forming apparatus according to an aspect of the present invention includes: the above image reading apparatus; and an image formation section forming an image onto paper on the basis of the image data generated by the original reading section.

According to this configuration, the image forming apparatus provided with the image reading apparatus is capable of heightening the disorder level in an encrypting key and disordering the random number further without any circuit dedicated to random-number generation, thereby suppressing a rise in costs for heightening the random-number disorder level.

This application is based on Japanese patent application serial No. 2007-304840, filed in Japan Patent Office on Nov. 26, 2007, the contents of which are hereby incorporated by reference.

Although the present invention has been fully described by way of example with reference to the accompanied drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image reading apparatus, comprising:
an original reading section reading an image from an original and generating image data on the read image;
a key generation section generating a key for encrypting on the basis of the image data generated by the original reading section;
an encrypting section encrypting the image data generated by the original reading section with the key generated by the key generation section; and
a transmission section transmitting the image data encrypted by the encrypting section to a terminal connected with the outside.

2. The image reading apparatus according to claim 1, wherein:
a storage section storing information is further provided;
the key generation section encrypts the generated key and stores this key in the storage section; and
the encrypting section decodes the key stored in the storage section and uses this key for encrypting the image data.

3. The image reading apparatus according to claim 1, wherein the key generation section generates the key by giving at least a part of the image data generated by the original reading section an arithmetic processing using a hash function.

4. The image reading apparatus according to claim 1, wherein the key generation section generates a pseudo-random number using at least a part of the image data generated by the original reading section as a random-number seed and sets the generated pseudo-random number as the key.

5. The image reading apparatus according to claim 1, wherein the key generation section acquires a least-significant bit for each word in at least a part of the image data generated by the original reading section and generates the key using the acquired plurality of least-significant bits.

6. The image reading apparatus according to claim 1, wherein:
a compression section is further provided which compresses the image data generated by the original reading section; and
the key generation section generates the key on the basis of the image data compressed by the compression section.

7. The image reading apparatus according to claim 6, wherein the key generation section generates the key by giving at least a part of the image data compressed by the compression section an arithmetic processing using a hash function.

8. The image reading apparatus according to claim 6, wherein the key generation section generates a pseudo-random number using at least a part of the image data compressed by the compression section as a random-number seed and sets the generated pseudo-random number as the key.

9. The image reading apparatus according to claim 6, wherein the key generation section acquires a least-significant bit for each word in at least a part of the image data compressed by the compression section and generates the key using the acquired plurality of least-significant bits.

10. An image forming apparatus, comprising:
the image reading apparatus according to claim 1; and
an image formation section forming an image onto paper on the basis of the image data generated by the original reading section.
